(19) United States
(12) Patent Application Publication
(10) Pub. No.: US 2007/0256783 A1
(43) Pub. Date: Nov. 8, 2007

(54) Thermally enhanced adhesive paste

(76) Inventors: Raymond L. Dietz, Merrimac, MA (US); Maciej Patelka, Brighton, MA (US)

Correspondence Address: Huntley and Assocs, 1105 N Market St, PO Box 948, Wilmington, DE, 19899, US

(21) Appl. No.: 11/801,156

(22) Filed: May 8, 2007

Related U.S. Application Data
(60) Provisional application No. 60/799,068, filed on May 8, 2006.

(51) Int. Cl. C09J 5/00

(52) U.S. Cl. 156/326; 524/403

(57) ABSTRACT

An adhesive paste with rounded filler particles results in improved thermal properties. The resultant compound maintains excellent quality for bonding high density, microcircuit electronic components to substrates.

### CROSS REFERENCE TO RELATED APPLICATION

This application is based on Provisional Application 60/799,068, filed on May 8, 2006.

### BACKGROUND OF THE INVENTION

The present invention relates to thermally enhanced adhesive pastes particularly well suited for bonding high density, microcircuit electronic components to substrates.

The attachment of high density, microcircuit components onto substrates, such as silicon dies onto ceramic sheet, has been an important aspect of the electronics industry for many years. Generally, it is known to use a die attach paste which is deposited between the die and substrate. Typically, the die attach paste includes a filler, an adhesive and a carrier. The filler is selected to impart to the finished bonding layer desired conductive, resistive or dielectric properties. The adhesive is chosen to create a strong bond between the die and substrate. The carrier maintains all the components in a fluid, uniform mixture, which allows the paste to be applied easily to the die-substrate interface. It also has suitable volatility to migrate from between the die and substrate following heat treatment of the assembly. After the paste is deposited and the die and substrate are assembled, the assembly is typically heated to fuse the adhesive and drive off the carrier. Upon cooling, the die is firmly attached to the substrate.

The power density of active components continues to rise, creating an increasing demand of higher thermally conductive adhesives to attach these components. These demands have previously been met by technologies described in the prior art, including U.S. Pat. Nos. 6,111,005 and 6,140,402. These patents describe a technology involving the use of powdered organic polymer resins, suspended in a non-solvent along with highly thermally conductive filler. The type of powered resin was varied depending on the application. For large area component attachments where the Coefficient of Thermal Expansion (CTE) mismatch to the substrate was also large, low modulus thermoplastic polymers were incorporated to handle the shear stress generated at the bondline of the adhesive. For smaller area components where the expansion mismatch to the substrate was lower, thermoset or combinations of thermoplastic and thermoset polymer powders were employed in the adhesive composition with the filler. The use of the higher modulus polymers also increased the thermal conductivity.

U.S. Pat. No. 6,265,471 describes an even higher thermal conductivity technology where the highly conductive filler is suspended in a liquid epoxy resin which is dissolved in a fugitive solvent. This technology increased the thermal conductivity over the prior technology described in U.S. Pat. Nos. 6,111,005 and 6,140,402. Unfortunately, the elastic modulus of the thermosetting liquid resin system was relatively high when cured or cross-linked. Consequently, the application of this technology was limited to small area component attach and or substrates that were closely matched in CTE to the component, usually a semiconductor die. The prior art described in the technologies described above clearly shows a linear relationship between the modulus and the thermal conductivity of the adhesive. Low modulus adhesives, described in U.S. Pat. Nos. 6,111,005 and 6,140,402, were lower in thermal conductivity, whereas the higher modulus adhesives described in U.S. Pat. No. 6,265,471 were higher in thermal conductivity. As higher function semiconductor devices grew in size and power, the need also grew for an adhesive with both high thermal conductivity and low modulus, such adhesives were needed to absorb the bondline shear stresses caused by the thermal expansion mismatch between the die and the high expansion, high thermally conductive substrates. One large application in the marketplace is the attachment of large area, flip chip microprocessor devices to a high expansion, high thermally conductive heat spreader. Both high conductivity and low modulus properties are needed for this application. Heretofore, the series of adhesives described in U.S. Pat. Nos. 6,111,005, 6,140,402 and 6,265,471 were used in this application. However, the microprocessor devices increased in power density and thus the demand increased for adhesives having even better thermal properties with low elastic modulus.

### SUMMARY OF THE INVENTION

The present invention provides die attach pastes which are strong, yet sufficiently elastic to bond large area silicon dies to more expandable substrates without inducing excessive stress yet provided significantly higher thermal properties than the present art. The invention also provides an adhesive with significantly enhanced thermal properties for the attachment of smaller components where the modulus of the cured adhesive is higher. The invention also provides an adhesive paste which can be applied by equipment and processes in the industry without major modifications and produce a bond line and when processed thereby. The invention also provides sufficient adhesion between the component and substrate to pass industry standards for adhesion. Furthermore, because the thermoplastic resins can be repeatedly melted and solidified, those embodiments of the invention are reworkable and suitable for multi-chip module technology.

Specifically, the present invention provides an adhesive paste comprising essentially of:
(A) about 2-20 weight percent organic polymer resin;
(B) up to 30 weight percent fugitive liquid; and
(C) about 5-98 weight percent inorganic filler;
   wherein the filler is present in particulate form and at least about 80% of the filler particles are characterized by round edges and substantially free from flat surfaces.

### DETAILED DESCRIPTION OF THE INVENTION

A detailed description of the principal components of the adhesive pastes of the present invention are described in U.S. Pat. Nos. 6,111,005 and 6,265,471. The key difference is the substitution of spherical shaped silver powders for the silver flakes in the adhesive composition, preferably in the presence of a sintering aid. The spherical powders produced a highly sintered, more dense structure than the same paste with silver flakes. This produces an unexpected decrease in the bulk electrical resistivity and an increase in thermal conductivity. Furthermore, the adhesion was increased which allowed for a decrease in the resin content (higher silver-to-resin ratio) which further increases the thermal conductivity.

The inorganic filler used in the adhesive pastes of the present invention is present in particulate form. At least about 80% of the filler particles, and preferably substantially all of the filler particles, are characterized by round edges, and substantially free from flat surfaces. Substantially spherical particles are especially preferred. It is also preferred that the inorganic filler be substantially free from surfactant. Representative of filler particles which can be use in the present invention are those available from Metalor Technologies USA of Attlebro, Mass. K82P and P318-8.

The inorganic filler is preferably used in combination with at least one sintering aid, that is, any additive that enhances the sintering of the filler. Representative sintering aids include metal resinates and silver oxides. The sintering aid is generally present in a concentration of about from 0.1 to 0.5 weight percent of the cured materials.

The unexpected increase in electrical and thermal properties is not fully understood, but is believed to be due to the better packing and point contacts of the spheres as compared to the geometry of the flakes previously used in plastics of this type. Also believed to be significant is the absence of a surfactant or lubricant present in the flaking process, which leaves a residue on the surface of the flake. This organic layer tends to thermally isolate one flake from another.

In the powder resin technology previously described, when the assembly is heated, the resin powder melts and coalesces with other particles and migrates toward the bondline interfaces. This melting of the powders leaves a void in the bondline, hereafter referred to “bond drop out” (BDO). This distribution of BDO voiding or porosity is considered a key property of the bondline and controls the shear stresses created by the mismatch in expansion of the two components being bonded. The size and amount of these pores is a direct function of the amount of resin an the size distribution of the polymer powders. Without the pores, the present invention provides a highly sintered silver filler which by itself is high in modulus of elasticity. The distribution of pores from the powdered resin melting reduces the modulus of elasticity of the cured bondline. Resin leaving creates pores. The final porosity is accordingly a function of the initial volume of the powdered resin.

The sphere has the smallest surface area among all surfaces enclosing a given volume, and it encloses the largest volume among all closed surfaces with a given surface area. Thus, the number of contacts between spheres would be lower in number than a flake for a given volume of filler. Since the primary path of thermal conductivity is through the bulk of the filler, for the highest flow of heat, the number of particle contacts per unit volume of filler should be kept to a minimum. The packing density of the filler is the other key factor in determining the heat flow. This packing density can be enhanced by the particle size distribution of the spheres as illustrated in the examples to follow.

The present adhesive pastes preferably further comprise up to about 3.0 weight % reducing agent. A wide variety of reducing agents can be used, including organic, inorganic, organometallic, or salt compounds. Representative of reducing agents which can be used are hydrazine, phenylhydrazine, N,N-diethylhydroxylamine, hydroxylamine phosphate (HAP), hydroxylamine sulfate (HAS), ammonium hydrogen sulfate, ammonium hydrogen phosphate (AUP), ammonium dihydrogen phosphate, ammonium nitrate, and ammonium sulfate.

Other sphere-like shapes can also be use in the present invention. In mathematics, a spheroid is a quadratic surface in three dimensions obtained by rotating an ellipse about one of its principal axes. Thus, a sphere is a special case of the spheroid in which the generating ellipse is a circle.

To illustrate the invention, combinations of filler, resin and fugitive liquid were combined in a paste. The preparation of the adhesive from its principal components, and its methods of application and use, take advantage of the various methods and employ equipment well known in the art. The principal components can be mixed in equipment known in the art for paste preparation. Details of this process are described in the prior art cited and referenced above.

The die attach adhesives of the present invention are typically used for attaching microcircuit electronic components to a substrate. In general, this comprises making an adhesive paste of the present invention; followed by applying the paste to a surface of a substrate to form a bond line and placing the electronic component on the bond line so that the paste is between the electronic component and the substrate; followed by heating the assembly to a sufficiently high temperature for a sufficient time that the organic thermoplastic resin softens and becomes fluid, but does not degrade, and the liquid devolatilizes from the paste; followed by cooling the heat-treated assembly to a temperature below which the thermoplastic polymer becomes solid, whereby the microcircuit electronic component is bonded to the substrate by a void-free bond line. When thermoset resin is used, rather than as a particle, as part or all of the organic polymer, the processing temperature should be sufficiently high to crosslink the resin.

For purposes of demonstrating the invention, the pastes are doctor bladed on a glass side, as well as deposited on a ceramic substrate before the die is placed on the wet adhesive. All curing was done at 200° C. peak for 30 minutes. After curing, a force perpendicular to the side of the die was applied until the die was sheared off the substrate. This force was recorded in psi as the adhesion value for the particular composition being test. The strips of adhesive on the glass slides were measured for resistance and recorded as a bulk resistivity in micro ohm-cm. This resisitivity value has a strong relationship to the thermal conductivity since the mechanism for thermal transport is by electrons, the same mechanism as in electrical conductivity. Because of the relationship between electrical resistance and thermal conductivity, the resisitivity value served as an indicator of which compositions would be further tested for thermal conductivity. The thermal conductivity measurements were done by the known laser flash method.

As used herein, the expression “consists essentially of” means that the composition may include additional components other than the principal, named components, provided that the additional components are not present in an amount sufficient to detract from the operability of the present invention.

The present invention is now illustrated by examples of certain representative embodiments thereof, where all parts, proportions, and percentages are by weight unless otherwise indicated. The examples are intended to be illustrative only, and modifications and equivalents of the invention will be evident to those skilled in the art.

### EXAMPLES 1-25 AND COMPARATIVE EXAMPLES A-D

In the Examples in Table 1 below, pastes were prepared by the procedure described above, and illustrate the impact of filler morphology on resistivity.

TABLE 1

| | | | | Tap- | Surface | | |
|---|---|---|---|---|---|---|---|
| | | Filler | | Density | Area | | Resistivity |
| Example # | Ag filler | ratio | Morphology | (g/cc) | (m2/g) | Polymer | ohm-cm |
| A | 67/80 | 50/50 | Flake-flake | 3.3–3.8/ | 1.4–2.0/ | None | 9.2 |
| | | | | 3.9–4.8 | 0.44–0.57 | | |
| 1 | 80/K82P | 50/50 | Flake- | 3.9–4.8/ | 0.44–0.57/ | None | 7.7 |
| | | | sphere | 4.9–6.0 | 0.7–1.9 | | |
| 2 | K82P/P318-8 | 50/50 | Sphere- | 4.9–6.0/ | 0.7–1.9/ | None | 5.4 |
| | | | sphere | 5.53 | 0.28 | | |
| 3 | 1081P/P318-8 | 50/50 | Sphere- | 3.6–6.9/ | 0.3–0.8/ | None | TBD |
| | | | sphere | 5.53 | 0.28 | | |

Examples in Table 2 below illustrate the impact of metal resinate on resistivity and thermal conductivity of the adhesive paste.

TABLE 2

| | | | | Silver | | Thermal | |
|---|---|---|---|---|---|---|---|
| | | Filler | | resinate | Polyester | conductivity | Resistivity |
| Example # | Ag filler | ratio | Morphology | AD9144 | polymer | (W/mK) | (ohm-cm) |
| 4 | K82P/P318-8 | 50/50 | Sphere- | 0% | 4709 | 7.76 | 94.7 |
| | | | sphere | | | | |
| 5 | K82P/P318-8 | 50/50 | Sphere- | 3% | 4709 | 5.1 | 38.1 |
| | | | sphere | | | | |
| 6 | K82P/P318-8 | 50/50 | Sphere- | 5% | 4709 | 20.1 | TBD |
| | | | sphere | | | | |
| 7 | 1081P/P318-8 | 50/50 | Sphere- | 0% | 4709 | 13.42 | 90.7 |
| | | | sphere | | | | |
| 8 | 1081P/P318-8 | 50/50 | Sphere- | 3% | 4709 | 34.03 | 21.4 |
| | | | shere | | | | |
| 9 | 1081P/P318-8 | 50/50 | Sphere- | 5% | 4709 | 30.16 | 20.0 |
| | | | sphere | | | | |

Examples in Table 3 below illustrate the impact of filler loading on resistivity.

TABLE 3

| | | | | | Polyester | Resistivity |
|---|---|---|---|---|---|---|
| Example # | Ag filler | Filler ratio | Morphology | Wt % filler | polymer | ohm-cm |
| 10 | K82P/P318-8 | 50/50 | Sphere-sphere | 92 | 4709 | 13.0 |
| 11 | K82P/P318-8 | 50/50 | Sphere-sphere | 93 | 4709 | 12.0 |
| 12 | K82P/P318-8 | 50/50 | Sphere-sphere | 94 | 4709 | 9.8 |

Examples in Table 4 below illustrate the impact of filler morphology in powdered resin system on resistivity and thermal conductivity. Example 14 represents the most preferred embodiment of the present invention.

TABLE 4

| | | | | | | Thermal | |
|---|---|---|---|---|---|---|---|
| | | Filler | | Wt % | | conductivity | Resistivity |
| Example # | Ag filler | ratio | Morphology | Polymer | Polymer | (W/mK) | ohm-cm |
| 13 | 80/K82P | 20/80 | Flake- | 8 | 4709 | 14.2 | 12.7 |
| | | | sphere | | | | |
| 14 | K82P/P318-8 | 50/50 | Sphere- | 7 | 4709 | 42.8 | 10.8 |
| | | | Sphere | | | | |

Examples in Table 5 below illustrate the impact of filler morphology in epoxy resin system on resistivity and thermal conductivity.

TABLE 5

| | | | | Tap- | Surface | | Thermal | Resistivity |
|---|---|---|---|---|---|---|---|---|
| | | Filler | | Density | Area | Epoxy | conductivity | ohm- |
| Example # | Ag filler | ratio | Morphology | (g/cc) | (m2/g) | Polymer | (W/mK) | cm |
| C | 80/113 | 50/50 | Flake- | 3.9–4.8/ | 0.44–0.57/ | 5415 | 30.8 | 9.6 |
| | | | flake | 4.5–5.4 | 0.7–1.2 | | | |
| 15 | K82P/P318-8 | 50/50 | Sphere- | 4.9–6.0/ | 0.7–1.9/ | 5415 | 44.7 | 9.2 |
| | | | sphere | 5.53 | 0.28 | | | |

Examples in Table 6 below illustrate the impact of filler morphology in another epoxy resin system on resistivity and thermal conductivity.

TABLE 6

| | | | | | Thermal | |
|---|---|---|---|---|---|---|
| | | Filler | | Epoxy | conductivity | Resistivity |
| Example # | Ag filler | ratio | Morphology | Polymer | (W/mK) | (ohm-cm) |
| D | 4561 | N/A | Flake | TH2-44-1 | 8.1 | 25.2 |
| 16 | K82P/P318-8 | 50/50 | Sphere- | TH2-44-1 | 32.22 | 26.2 |
| | | | sphere | | | |

As the examples illustrate, the inclusion of a sphere shaped particles of Ag, in the presence of a Ag resinate as a sintering aid, yielded significantly lower electrical resistance and higher thermal conductivity, although the relationship was not always linear.

TABLE 7

| | | | | | Amount | | | |
|---|---|---|---|---|---|---|---|---|
| | | | | | of | | Thermal | |
| | Ag | Filler | | Reducing | Reducing | Polyester | conductivity | Resistivity |
| Example # | filler | ratio | Morphology | agent | agent (%) | Polymer | (W/mK) | (ohm-cm) |
| 17 | K82P/ | 50/50 | Sphere- | none | 0% | 4709 | 5.1 | 38.1 |
| | P318-8 | | sphere | | | | | |
| 18 | K82P/ | 50/50 | Sphere- | HAS | 0.2% | 4709 | 32.1 | 17.3 |
| | P318-8 | | sphere | | | | | |
| 19 | K82P/ | 50/50 | Sphere- | HAP | 0.2% | 4709 | 9.01 | 15.9 |
| | P318-8 | | sphere | | | | | |
| 20 | K82P/ | 50/50 | Sphere- | AHP | 0.2% | 4709 | 30.4 | 14.5 |
| | P318-8 | | sphere | | | | | |
| 21 | 1081P/ | 50/50 | Sphere- | none | 0% | 4709 | 34.03 | 21.4 |
| | P318-8 | | sphere | | | | | |
| 22 | 1081P/ | 50/50 | Sphere- | AHP | 0.2% | 4709 | 33.73 | 1.7.6 |
| | P318-8 | | sphere | | | | | |

### Examples in Table 8 below illustrate the impact of pressure during curing on interfacial thermal resistance.

TABLE 8

| | | | | | | Interfacial |
|---|---|---|---|---|---|---|
| | | | | | Bond line | thermal |
| Ex- | | Filler | Pressure | Epoxy | thickness | resistance |
| ample # | Ag filler | ratio | (psi) | Polymer | (mils) | (Kcm2/W) |
| 23 | 1081P/P318 | 50/50 | 11 | 4709 | 2.2 | 0.0519 |
| 24 | 1081P/P318 | 50/50 | 22 | 4709 | 1.8 | 0.0425 |
| 25 | 1081P/P318 | 50/50 | 0 | 4709 | 1.8 | 0.0561 |

We claim:

1. An adhesive paste consisting essentially of:
(a) about 2-20 weight percent organic resin;
(b) up to 30 weight percent fugitive liquid; and
(c) about 5-98 weight percent inorganic filler;
wherein the inorganic filler is present in particulate form and at least about 80% of the filler particles are characterized by round edges and substantially free from flat surfaces.

2. An inorganic filler of claim 1 further characterized by:
a. a surface area of about from 0.20 to 2.0 m2/gm
b. a tap density of 3 to 6 gm/cc

3. An adhesive paste of claim 1 wherein the organic resin is selected from thermoset and thermoplastic and resins and mixtures thereof.

4. An adhesive paste of claim lwherein the resin is in liquid or particulate form.

5. An adhesive paste of claim 1 wherein the resin consists essentially of at least one thermoplastic resin.

6. An adhesive paste of claim 1 wherein the resin consists essentially of at least one thermoset resin.

7. An adhesive paste of claim 5 wherein the resin is selected from at least one of: polyesters, copolyesters, polyamides, copolyamides, nylons, polyurethanes, polybutylene teraphthalate, polyolefins, acrylics, silicones, and liquid crystalline polymers.

8. An adhesive paste of claim 6 wherein the resin is selected from at least one of: epoxy, silicones, reactive polyesters, polyurethanes and polyimides.

9. An adhesive paste of claim 1 further comprising up to 1.0 weight % sintering aid.

10. An adhesive paste of claim 9 wherein the sintering aid consists essentially of at least one organometallic compound.

11. An adhesive paste of claim 10 wherein the organometallic compound consists essentially of metal resinate.

12. An adhesive paste of claim 9 wherein the sintering aid consists essentially of silver resinate.

13. An adhesive paste of claim 1 wherein the inorganic filler consists essentially of metal particles.

14. An adhesive paste of claim 13 wherein metal particles are at least one selected from silver, copper, gold, and solder.

15. An adhesive paste of claim 1 wherein the particle size of inorganic filler is less than about 110 microns.

16. An adhesive paste of claim 1 wherein the shape of inorganic filler is selected from at least one of spheres, oblates, spheroids, oblong spheroids, and ellipsoids.

17. An adhesive paste of claim 1 wherein the furgitive liquid comprises an effective amount of at least one viscosity modifier.

18. An adhesive paste of claim 17 wherein the viscosity modifier comprises about from 0.05 to 5 volume % of the adhesive paste.

19. An adhesive paste of claim 17 wherein the viscosity modifier comprises at least one selected from styrene-butadiene-styrene, styrene-isoprene-styrene, styrene ethylenelbutylene-styrene, styrene-ethylene/propylene-styrene, styrene-butadiene, styrene-butadiene-styrene, styrenic block copolymers, and polyisobutylene.

20. An adhesive paste of claim 1 further comprising up to about 5.0 weight % reducing agent.

21. An adhesive paste of claim 20 wherein the reducing agent consists essentially of at least one organic compound, inorganic salt compound, or organometallic compound.

22. An adhesive paste of claim 21 wherein the salt compound is selected from at least one selected from the group consisting of: hydrazine, phenylhydrazine, N,N-diethylhydroxylamine, hydroxylamine phosphate, hydroxylamine sulfate, ammonium hydrogensulfate, ammonium hydrogen phosphate, ammonium dihydrogen phosphate, ammonium nitrate, and ammonium sulfate.

23. A process for assembling an electronic component on a substrate, comprising the steps of:
(A) Depositing an adhesive paste on a substrate, the paste consisting essentially of:
(i) about from 5 to 50 weight % of organic resin;
(ii) up to 30 weight % of fugitive liquid; and
(iii) about from 5 to 80 weight % of inorganic filler;
wherein the inorganic filler is present in particulate form and at least about 80% of the filler particles are characterized by round edges and substantially free from flat surfaces.
(B) Placing an electronic component on the substrate in contact with the adhesive paste;
(C) Heating the resulting assembly to a temperature above which the resin softens and bonds or which the resin cross links with time to form an adhesive bond of the two components; and
(D) Cooling the assembly to room temperature.

24. A process for assembling an electronic component or a substrate comprising the steps of:
(A) Depositing an adhesive according to claim 1 on an electronic component or substrate;
(B) Partially curing the adhesive on the component or substrate; and
(C) Applying heat and pressure sufficient to bond the component to the substrate.

25. An article made by the process of claim 23.

26. An article made by the process of claim 24.

27. A sintered adhesive paste of claim 1 comprising up to about 60 volume % voids.
